(19) United States
(12) Patent Application Publication
(10) Pub. No.: US 2016/0292628 A1
(43) Pub. Date: Oct. 6, 2016

(54) METHOD, AND STORAGE MEDIUM

(71) Applicant: FUJITSU LIMITED, Kawasaki-shi (JP)

(72) Inventor: Shinji NAGAMATSU, Fukuoka (JP)

(73) Assignee: FUJITSU LIMITED, Kawasaki-shi (JP)

(21) Appl. No.: 15/079,252

(22) Filed: Mar. 24, 2016

(30) Foreign Application Priority Data
Mar. 31, 2015 (JP) 2015-074645

(51) Int. Cl. G06Q 10/08; G06T 7/00

(52) U.S. Cl. CPC G06Q 10/087; G06T 7/004

(57) ABSTRACT

A method executed by a computer, the method includes: acquiring a captured image in which a product display shelf is image-captured; detecting, from the captured image, first identification information associated with a first position in the product display shelf and second identification information associated with a second position in the product display shelf; and determining that a display position of a product exists between the first position and the second position, in a case where product identification information associated with the product is detected at a position between the first identification information and the second identification information in the captured image.

### CROSS-REFERENCE TO RELATED APPLICATION

This application is based upon and claims the benefit of priority of the prior Japanese Patent Application No. 2015-074645, filed on Mar. 31, 2015, the entire contents of which are incorporated herein by reference.

### FIELD

The embodiments discussed herein are related to a method, and a storage medium.

### BACKGROUND

Sales assistants in, for example, a mass retailer draft a display plan (planogram plan) of products and adjust display positions and display quantities of products, thereby working hard to increase productivity of a selling space. Even if products are displayed in accordance with the display plan, business operations cause products to be changed or replenished, and display positions of products are changed from an original display plan in some cases. Therefore, next time the sales assistants draft a display plan of products, displayed products are individually scanned and checked, by using handheld terminals, in order to understand current display states of the respective products.

As an example of the related art, Japanese Laid-open Patent Publication No. 2013-250647 is known.

### SUMMARY

According to an aspect of the invention, a method executed by a computer, the method includes: acquiring a captured image in which a product display shelf is image-captured; detecting, from the captured image, first identification information associated with a first position in the product display shelf and second identification information associated with a second position in the product display shelf; and determining that a display position of a product exists between the first position and the second position, in a case where product identification information associated with the product is detected at a position between the first identification information and the second identification information in the captured image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a hardware configuration of a processing device;

FIG. 2 illustrates an example of a captured image in which a product display shelf is image-captured;

FIG. 3A illustrates an example of a product display position master;

FIG. 3B illustrates an example of a product identification information master;

FIG. 3C illustrates an example of a position identification information master;

FIG. 4 illustrates examples of respective positions in the product display shelf;

FIG. 5 is a flowchart illustrating an example of a determination processing method for a product display position according to a first embodiment;

FIG. 6 illustrates an example of a captured image in which the product display shelf is image-captured;

FIG. 7 is a flowchart illustrating an example of a determination processing method for a product display position according to a second embodiment;

FIG. 8 illustrates an example of a captured image in which the product display shelf is image-captured;

FIG. 9 illustrates an example of a determination processing result screen; and

FIG. 10 is a flowchart illustrating an example of a determination processing method for a product display position according to a third embodiment.

### DESCRIPTION OF EMBODIMENTS

A scanning and checking work, which is used for understanding current display states of products and which utilizes a handheld terminal, takes many man-hours and is inconvenient.

In one aspect, the present embodiment enables a display position of a product to be easily detected.

Hereinafter, individual embodiments will be described in detail with reference to accompanying drawings. Individual processing operations in the individual embodiments may be arbitrarily combined. Note that, in all the drawings for explaining the individual embodiments, the same symbol will be assigned to the same unit as a rule and the repetitive description thereof will be omitted.

### First Embodiment

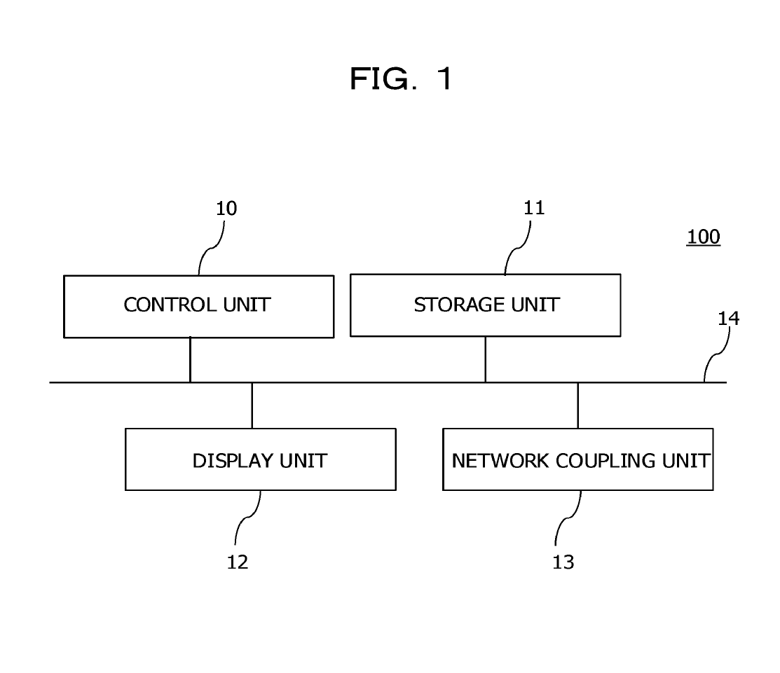

An example of a hardware configuration of a determination processing device (hereinafter, called a processing device 100) for a product display position according to each of the embodiments of the present technology will be described by using FIG. 1. FIG. 1 is a diagram illustrating an example of a hardware configuration of the processing device 100. As the processing device 100, an information processing device such as, for example, a personal computer (PC), a tablet terminal, a smartphone, or a handheld terminal may be used. A determination processing program (for example, software) in each of the embodiments is installed into the processing device 100. By using the installed determination processing program, the processing device 100 performs determination processing for a product display position, described later.

The processing device 100 includes a control unit 10, a storage unit 11, a display unit 12, and a network coupling unit 13, and these are coupled to one another via a system bus 14.

The control unit 10 is a device that controls the processing device 100. As the control unit 10, an electronic circuit such as a central processing unit (CPU) or a micro processing unit (MPU) may be used. Based on an operating system (OS) and various kinds of programs, stored in the storage unit 11, the control unit 10 controls processing operations such as various kinds of arithmetic operations and inputting and outputting of data from and to individual hardware configuration units. Various kinds of information and so forth, used during execution of a program, are acquired from, for example, the storage unit 11. Note that various kinds of processing operations may be realized by using dedicated hardware.

The storage unit 11 may include a main storage device and an auxiliary storage device. The main storage device temporarily stores therein, for example, at least some of the OS and application programs caused to be executed by the control unit 10. In addition, the main storage device stores therein various kinds of data to be used in processing based on the control unit 10. As the main storage device, for example, a read only memory (ROM), a random access memory (RAM), or the like may be used.

The auxiliary storage device stores therein, for example, execution programs according to the respective embodiments, a control program provided in a computer, and so forth. Based on a control signal from the control unit 10, the auxiliary storage device reads various kinds of information stored therein and writes various kinds of information thereinto. As the auxiliary storage device, a storage such as, for example, a hard disk drive (HDD) or a solid state drive (SSD) may be used. The auxiliary storage device may store therein pieces of information used in processing operations of the respective embodiments. In addition, the main storage device and the auxiliary storage device may play each other's functions.

Based on a control signal from the control unit 10, the display unit 12 displays an execution process of a program and a result and so forth of the determination processing for a product display position according to each of the embodiments. As the display unit 12, for example, a liquid crystal display or the like may be used.

Based on a control signal from the control unit 10, the network coupling unit 13 communicates with another terminal, a server, and so forth via a communication network. As the network coupling unit 13, a communication circuit such as, for example, a network interface card (NIC) or a wireless communication unit compliant with the IEEE 802.11 standard may be used. The communication network is, for example, a wireless communication network, and the network coupling unit 13 communicates with other devices and so forth by performing wireless communication that utilizes a wireless communication unit. The processing device 100 acquires various kinds of programs, setting information, and so forth from the other devices and so forth, coupled via the network coupling unit 13. In addition, the network coupling unit 13 is used for providing, to other devices and so forth, a determination result in each of the embodiments, obtained by executing a program.

Based on such a hardware configuration as described above, the processing device 100 executes determination processing in each of the embodiments. In the processing device 100 according to each of the embodiments, by installing, into, for example, a general-purpose PC or the like, a program for causing a computer to perform the individual functions, hardware resources and software collaborate with each other, thereby performing the determination processing in each of the embodiments.

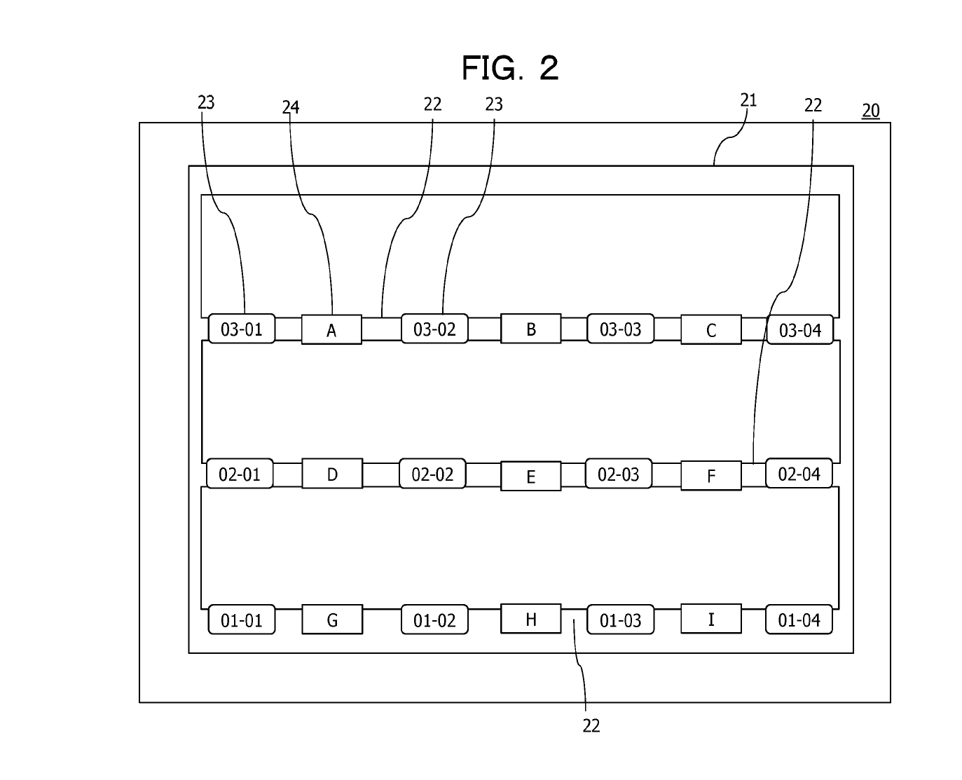

FIG. 2 illustrates an example of a captured image 20 in which a product display shelf 21 is image-captured. As illustrated in FIG. 2, the product display shelf 21 includes two side plates placed at a predetermined interval and shelf plates 22 almost horizontally supported by these side plates. Note that while, in FIG. 2, the three shelf plates 22 are illustrated, the number of the shelf plates is not limited to this. The product display shelf 21 according to each of the embodiments may include, for example, one, two, or four or more shelf plates 22. Labels (hereinafter, called position labels) 23, to which respective pieces of position identification information for identifying respective positions of the product display shelf 21 are assigned, and labels (hereinafter, called product labels) 24, to which respective pieces of product identification information for identifying respective products displayed on the product display shelf 21 are assigned, are attached on the front side surfaces of the respective shelf plates 22. The pieces of position identification information are pieces of identification information associated with the respective positions in the product display shelf 21. As each of the pieces of position identification information, a code including numerical values, alphabets, and so forth may be used, and for example, a bar code, a QR code (registered trademark), a Chameleon code (registered trademark), or the like may be used. In addition, the pieces of product identification information are pieces of identification information associated with respective products. As each of the pieces of product identification information, a code including numerical values, alphabets, and so forth may be used, and a Japanese Article Number (JAN) code may be used in addition to, for example, the bar code, the QR code (registered trademark), the Chameleon code (registered trademark), or the like.

Hereinafter, various kinds of processing operations of the processing device 100 according to the first embodiment will be described in detail with reference to FIGS. 1, 2, 3A, 3B, and 3C.

The control unit 10 detects the pieces of position identification information and the pieces of product identification information, included in the captured image 20 in which the product display shelf 21 is image-captured. The control unit 10 identifies, based on detection results of the pieces of position identification information, positions corresponding to the respective pieces of position identification information and identifies, based on detection results of the pieces of product identification information, products corresponding to the respective pieces of product identification information.

Based on detection results of the pieces of position identification information and the pieces of product identification information, the control unit 10 identifies coordinates on the captured image 20 for each of the pieces of position identification information and the pieces of product identification information. Regarding the coordinates, for example, the left lower end of the captured image 20 may be defined as an origin, an X-axis may be defined in the lateral direction of the captured image 20, a Y-axis may be defined in the longitudinal direction of the captured image 20, and the numerical values of the X-axis and the Y-axis may be set for each of pixels of the captured image 20. In addition, the central position of each of the position labels 23 may be defined as the position of the corresponding one of the pieces of position identification information, and the central position of each of the product labels 24 may be defined as the position of the corresponding one of the pieces of product identification information.

The control unit 10 detects one of the pieces of product identification information, which exists between the two pieces of position identification information adjacent to each other among the pieces of position identification information whose coordinates are identified. In a case where one of the pieces of product identification information is detected between the two pieces of position identification information adjacent to each other, the control unit 10 determines that a product associated with the detected piece of product identification information is displayed between positions associated with the respective two pieces of position identification information adjacent to each other. Furthermore, based on the determination result, the control unit 10 performs recording on a product display position master 30.

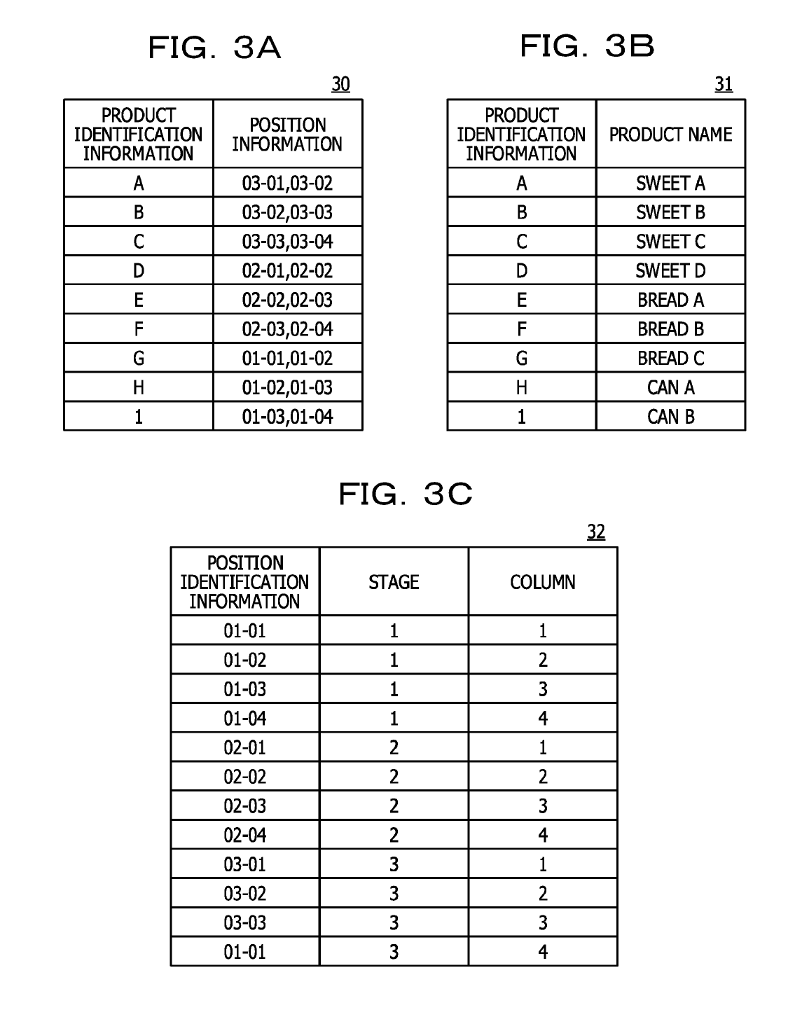

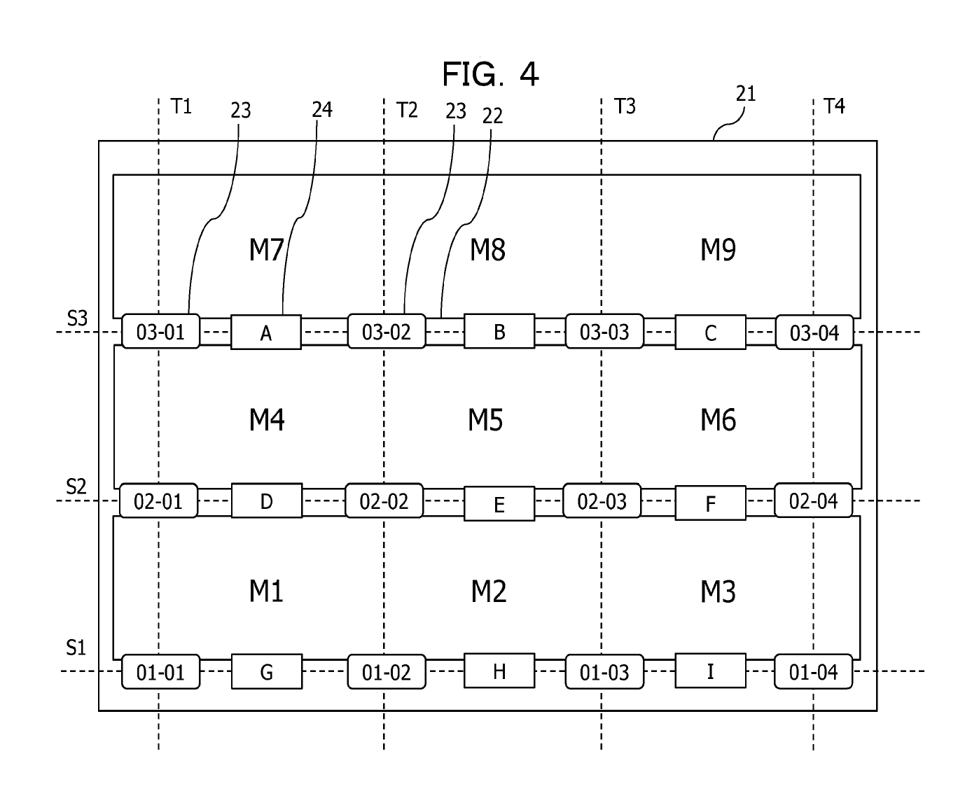

The storage unit 11 stores therein the product display position master 30. FIG. 3A illustrates an example of the product display position master 30. As illustrated in FIG. 3A, the product display position master 30 is information for associating the pieces of product identification information and position information with each other. The position information according to the present embodiment includes two pieces of position identification information. “03-01” and “03-02” are recorded, as the position information, in a record in, for example, the first row of the product display position master 30. In this case, the position information turns out to indicate a position in an area between a position at which the corresponding one of the pieces of position identification information is “03-01” and a position at which the corresponding one of the pieces of position identification information is “03-02”. FIG. 4 illustrates examples of respective positions in the product display shelf 21. Regarding the individual positions in the product display shelf 21, as illustrated by for example, symbols S1 to S3 and symbols T1 to T4 in FIG. 4, stages (whose stage numbers are each indicated by Sn) are defined in the longitudinal direction of the product display shelf 21, columns (whose column numbers are each indicated by Tn) in the lateral direction thereof, and the pieces of position identification information may be identified by combinations of these stage numbers and these column numbers. For example, the piece of position identification information, “03-02”, indicates a position corresponding to the third stage and the second column of the product display shelf 21.

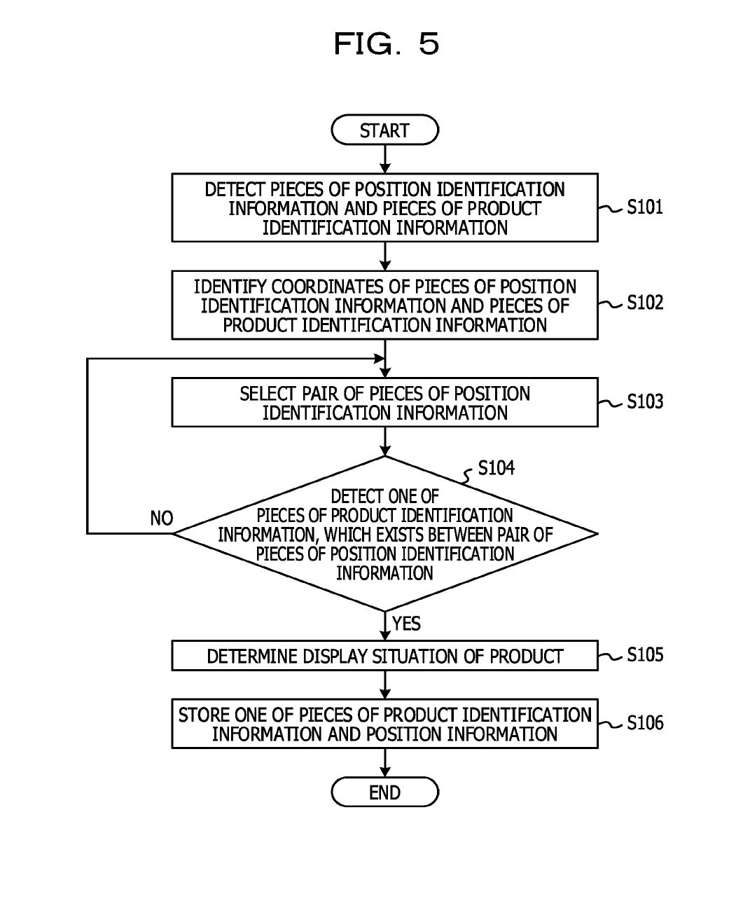

Subsequently, the flow of a determination processing method for a product display position according to the first embodiment will be described with reference to FIG. 5. FIG. 5 is a flowchart illustrating an example of the determination processing method for a product display position according to the first embodiment.

The control unit 10 acquires the captured image 20 of the product display shelf 21, image-captured by an imaging device, and detects the pieces of position identification information and the pieces of product identification information, included in the acquired captured image 20 (S101). Subsequently, for the detected pieces of position identification information and the detected pieces of product identification information, the control unit 10 identifies coordinates on the captured image 20 (S102).

Subsequently, based on the identified coordinates of the pieces of position identification information, the control unit 10 selects a pair of pieces of position identification information adjacent to each other (S103). Furthermore, based on the identified coordinates of the pieces of position identification information and the identified pieces of product identification information, the control unit 10 detects one of the pieces of product identification information, which exists between the selected pair of pieces of position identification information (S104).

In a case where one of the pieces of product identification information is detected (S104: Yes), the control unit 10 determines that a product associated with the detected piece of product identification information is displayed between two positions associated with the selected pair of pieces of position identification information (S105), and based on a result obtained by the determination, the control unit 10 records, in the product display position master 30, the piece of product identification information and the position information while associating the piece of product identification information and the position information with each other (S106).

On the other hand, in a case where no piece of product identification information is detected (S104: No), the control unit 10 returns to the processing operation in S103 and selects again another pair of pieces of position identification information adjacent to each other. After that, in the same way, the control unit 10 performs the processing operations ranging to S106.

For each combination of two pieces of position identification information adjacent to each other, the control unit 10 performs the processing operations in S101 to S106. From this, for every combination of pieces of position identification information adjacent to each other and included in the captured image 20, which product is displayed is determined or whether no product is displayed is determined.

According to the first embodiment, based on the pieces of position identification information and the pieces of product identification information, included in the captured image 20, display situations of products are determined. From this, a position registration work based on a user may be omitted. In addition, even in the product display shelf 21 in which a large number of products are displayed, display positions of the products are collectively understood.

Note that in a case where the processing device 100 includes an image capturing unit, the determination processing for display positions of products may be performed based on the captured image 20 acquired by the image capturing unit in the processing device 100. In addition, the processing device 100 may acquire, via a network, a storage medium, or the like, the captured image 20 image-captured by another terminal, a fixed camera such as a monitoring camera, or the like and may determine the display situations of the products, based on the acquired captured image 20.

Note that while the present embodiment is described on the assumption that one of the pieces of product identification information exists between a pair of pieces of position identification information adjacent to each other, the present embodiment is not limited to this. In a case where pieces of product identification information exist between, for example, a pair of pieces of position identification information adjacent to each other, common position information may be recorded for these products.

In addition, while, in the present embodiment, the pieces of product identification information and the position information are recorded in the product display position master 30, the present embodiment is not limited to this. In place of, for example, the pieces of product identification information, information related to products associated with the pieces of product identification information may be recorded. As the information related to products, for example, names, prices, or the like of products may be used. In a case of using the information of products, a product identification information master 31 only has to be stored in the storage unit 11. FIG. 3B illustrates an example of the product identification information master 31. As illustrated in FIG. 3B, the product identification information master 31 is information for associating the pieces of product identification information and information related to products with each other. As described above, if the product identification information master 31 is stored in the storage unit 11, it is possible for the control unit 10 to acquire the information related to products associated with the pieces of product identification information, by referencing the product identification information master 31.

In addition, while, in the present embodiment, two pieces of position identification information are recorded in the product display position master 30, the present embodiment is not limited to this. In a case where the product display shelf 21 is partitioned into, for example, columns, information indicating a stage number and a column number of the product display shelf 21 may be used in place of the two pieces of position identification information. In a case of using the stage number and the column number, a position identification information master 32 only has to be stored in the storage unit 11. FIG. 3C illustrates an example of the position identification information master 32. As illustrated in FIG. 3C, the position identification information master 32 is information for associating the pieces of position identification information and the information indicating the stage number and the column number with each other. As described above, if the position identification information master 32 is stored in the storage unit 11, it is possible for the control unit 10 to acquire the information indicating the stage number and the column number, associated with the pieces of position identification information, by referencing the position identification information master 32.

In addition, as the position information of the product display position master 30, area identification information for identifying individual areas of the product display shelf 21 may be used. As illustrated in FIG. 4, pieces of area identification information (M1 to M9) are assigned to respective areas of the product display shelf 21 partitioned in a matrix state. As described above, by using the pieces of area identification information (M1 to M9) for identifying areas, it is possible to simply identify product display positions.

Note that some or all of the product display position master 30, the product identification information master 31, and the position identification information master 32 may be stored in a storage unit in an external device coupled to the processing device 100 via a network.

### Second Embodiment

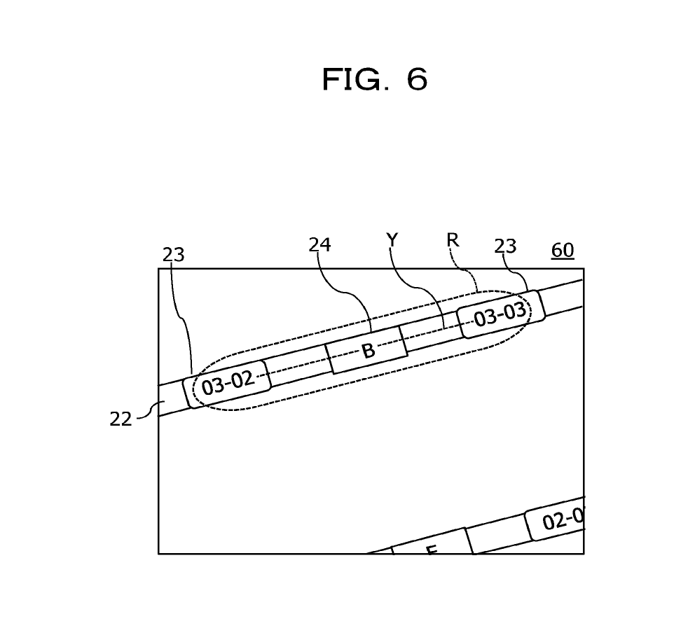

Next, various kinds of processing operations of the processing device 100 according to a second embodiment will be described in detail. FIG. 6 illustrates an example of a captured image 60 in which the product display shelf 21 is image-captured.

As illustrated in FIG. 6, in a case where one of the pieces of product identification information existing on a line segment Y whose two ends are positions (for example, the centers of the respective position labels 23) associated with a pair of respective pieces of position identification information is detected, the control unit 10 according to the second embodiment determines that a product associated with the piece of product identification information is displayed between the two positions associated with these respective pieces of position identification information 2. In this regard, however, there is no limitation to this, and in a case where one of the pieces of product identification information existing within a range (range R) located within a given distance from the line segment Y is detected, the control unit 10 may determine that a product associated with the detected piece of product identification information is displayed between the positions associated with the respective two pieces of position identification information.

Here, the range R may be specified by a given number of pixels of the captured image 60 and may be specified based on a given length (for example, 5 cm) in the real world. In addition, the range R may be preliminarily set and may be input and set every time the determination processing is performed.

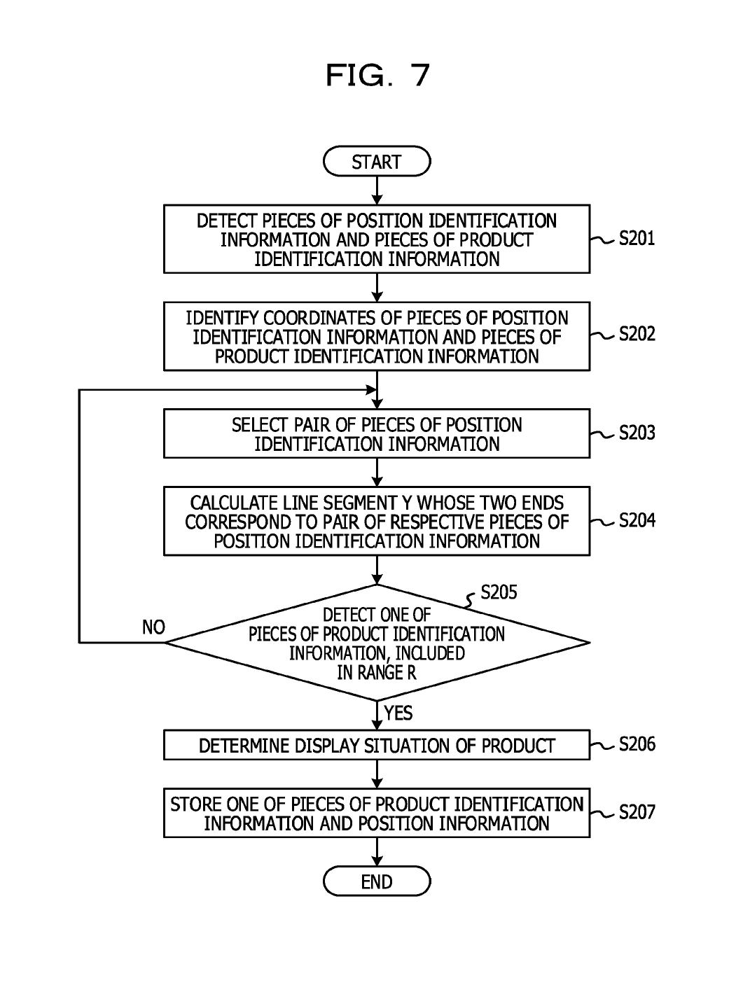

Subsequently, the flow of a determination processing method for a product display position according to the second embodiment will be described with reference to FIG. 7. FIG. 7 is a flowchart illustrating an example of the determination processing method for a product display position.

The control unit 10 acquires the captured image 60 of the product display shelf 21, image-captured by, for example, an imaging device, and detects the pieces of position identification information and the pieces of product identification information, included in the acquired captured image 60 (S201). Subsequently, for the detected pieces of position identification information and the detected pieces of product identification information, the control unit 10 identifies coordinates on the captured image 60 (S202).

Subsequently, based on the identified coordinates of the pieces of position identification information, the control unit 10 selects a pair of pieces of position identification information adjacent to each other (S203). Furthermore, based on the identified coordinates of the pieces of position identification information, the control unit 10 calculates the line segment Y whose two ends are two positions associated with the selected pair of respective pieces of position identification information (S204). Based on the calculated line segment Y, the control unit 10 detects one of the pieces of product identification information included in the range R (S205).

In a case where one of the pieces of product identification information is detected (S205: Yes), the control unit 10 determines that a product associated with the detected piece of product identification information is displayed between two positions associated with the selected pair of pieces of position identification information (S206), and based on the determination result, the control unit 10 records, in the product display position master 30, the piece of product identification information and the position information while associating the piece of product identification information and the position information with each other (S207).

On the other hand, in a case where no piece of product identification information is detected (S205: No), the control unit 10 returns to the processing operation in S203 and selects again another pair of pieces of position identification information adjacent to each other. After that, in the same way, the control unit 10 performs the processing operations ranging to S207.

For each combination of two pieces of position identification information adjacent to each other, the control unit 10 performs the processing operations in S201 to S207. From this, for every combination of pieces of position identification information adjacent to each other and included in the captured image 60, which product is displayed is determined or whether no product is displayed is determined.

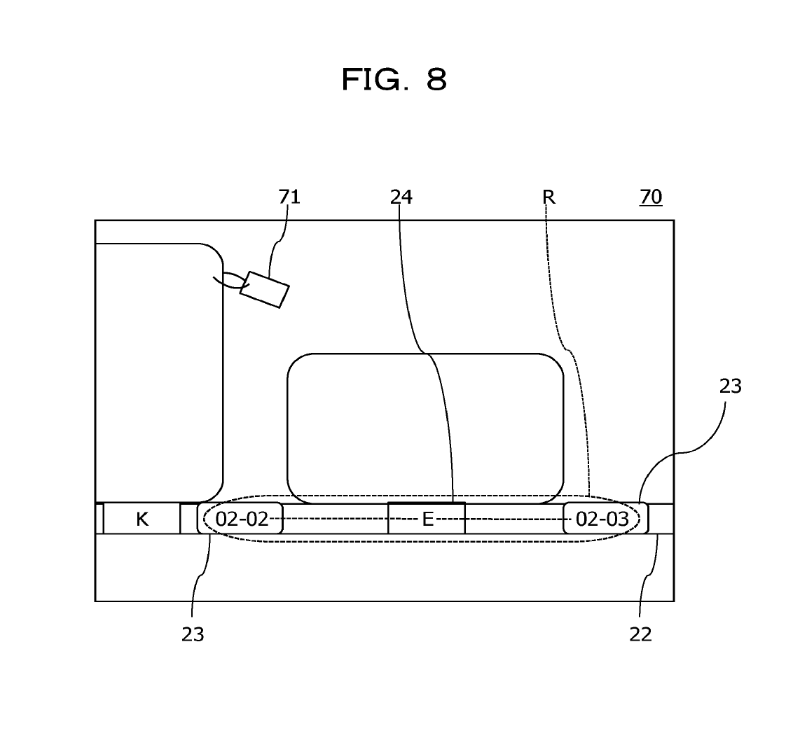

According to the second embodiment, the line segment Y is calculated from the pieces of position identification information, and the line segment Y is used, thereby determining positions of the pieces of product identification information. Therefore, even in a state in which the product display shelf 21 tilts in the captured image 60, a display situation of a product is adequately determined. In addition, in the processing device 100, by performing, based on the range R, the determination processing, a price tag 71 (in which, for example, the JAN code, the bar cod, or the like is described) or the like, attached to a product as illustrated in, for example, FIG. 8, is inhibited from being falsely recognized as one of the product labels 24. FIG. 8 illustrates an example of a captured image 70 in which the product display shelf 21 is image-captured.

Note that the storage unit 11 may include a standard image size master. The standard image size master records therein standard sizes on an image of the pieces of position identification information and the pieces of product identification information included in the captured image 60.

In this case, the control unit 10 may reference the standard image size master and may compare the size of the corresponding one of pieces of position identification information included in the captured image 60 with a standard size recorded in the standard image size master, thereby determining a display situation of a product by using the range R of a size, which corresponds to a comparison result. From this, even if the size of the product display shelf 21 on the captured image 60 differs depending on, for example, an installation position of the imaging device, in other words, a distance from the imaging device to the product display shelf 21, the display situation of a product is adequately determined. At this time, by correcting a preliminarily set standard size of the range R, based on a result of a comparison between the size of the image-captured piece of position identification information and the standard size, the ranges R of various kinds of sizes may be obtained.

Furthermore, in a case where the processing device 100 includes an image capturing unit, the control unit 10 may display, on the display unit 12 in real time, an image acquired by the image capturing unit in the processing device 100 while superimposing the range R on the relevant image. From this, in, for example, a case where a user image-captures the captured image 60, it is possible for the user to confirm, on the screen of the display unit 21, the range R, in other words, a range in which one of the pieces of product identification information is detected.

Note that in a case where the processing device 100 includes the image capturing unit, the determination processing for display positions of products may be performed based on the captured image 60 acquired by the image capturing unit in the processing device 100. In addition, the processing device 100 may acquire, via a network, a storage medium, or the like, the captured image 60 image-captured by another terminal, a fixed camera such as a monitoring camera, or the like and may determine the display situations of the products, based on the acquired captured image 60.

### Third Embodiment

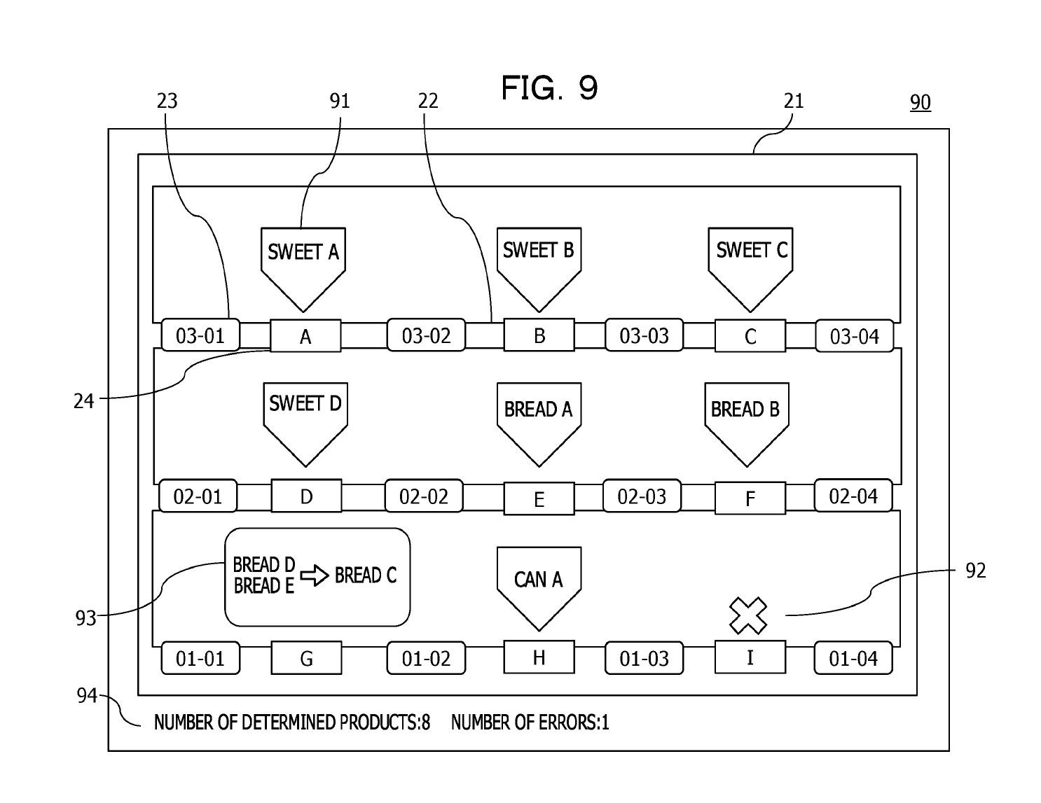

Next, various kinds of processing operations of the processing device 100 according to a third embodiment will be described in detail. FIG. 9 illustrates an example of a determination processing result screen 90.

Based on a result of the determination processing for the display situations of products, the control unit 10 according to the third embodiment outputs to the display unit 12. As illustrated in, for example, FIG. 9, the control unit 10 displays, on the display unit 12, the determination processing result screen 90 including a determination result of the display situations of products.

The determination processing result screen 90 includes, for example, product name displays 91 corresponding to the pieces of product identification information, an error display 92 corresponding to one of the pieces of product identification information whose position fails to be determined due to any cause, an update information display 93 indicating displayed products before and after the determination processing, a display 94 of the number of determination operations and the number of errors, and so forth. As the determination processing result screen 90, a captured image used for, for example, determination of the display situations of products may be used.

In this case, regarding the pieces of product identification information associated with the position information, the control unit 10 may reference the product identification information master 31 and may superimpose and display information related to products associated with the pieces of product identification information while associating the information related to products with the pieces of product identification information of the captured image. As the information related to products, for example, names, prices, or the like of the products may be used.

In addition, regarding one of the pieces of product identification information, not associated with the position information, the control unit 10 may display the error display 92 while associating the error display 92 with the corresponding one of the pieces of product identification information of the captured image.

In addition, the control unit 10 may store, in the storage unit 11, determination results up to a previous one. Based on the previous determination result stored in the storage unit 11, the control unit 10 may cause the update information display 93 to be displayed, the update information display 93 indicating displayed products before and after the determination processing. In FIG. 9, the update information display 93 illustrates an example that displayed products were changed from breads D and E in the previous determination result to a bread C.

Note that while, in the present embodiment, the determination processing result screen 90 is created by using the captured image, a determination processing result screen is not limited to this if it is possible to understand products displayed on the product display shelf 21 and positions at which the products are displayed. A text display indicating, for example, a correspondence relationship between the pieces of product identification information and the pieces of position identification information may be performed.

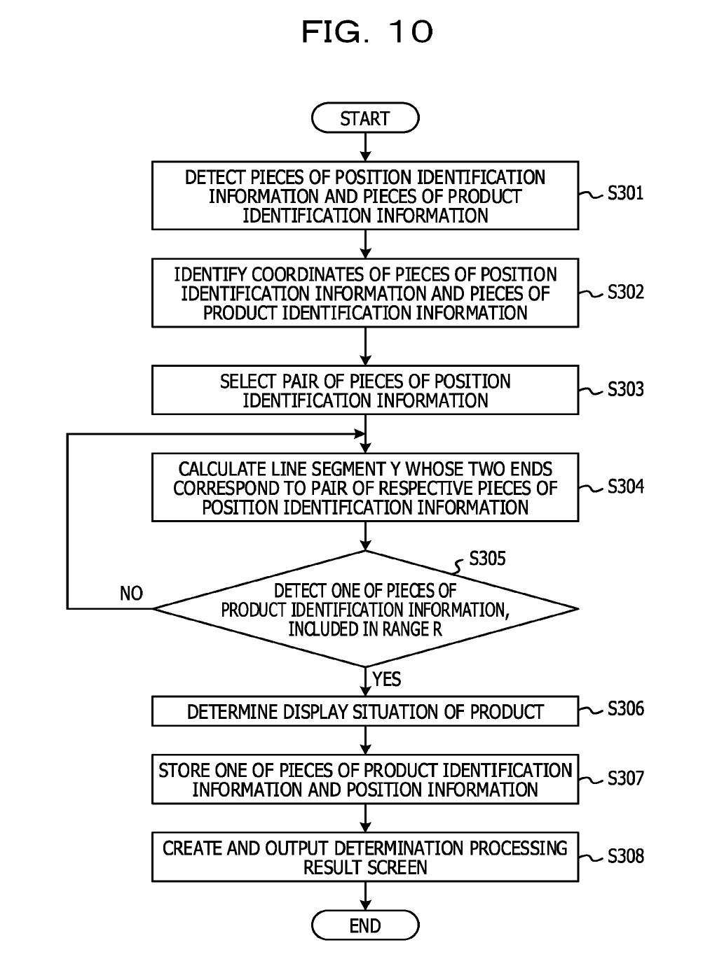

Subsequently, the flow of a determination processing method for a product display position according to the third embodiment will be described with reference to FIG. 10. FIG. 10 is a flowchart illustrating an example of the determination processing method for a product display position.

The control unit 10 acquires the captured image of the product display shelf 21, image-captured by the imaging device, and detects the pieces of position identification information and the pieces of product identification information, included in the acquired captured image (S301). Subsequently, for the detected pieces of position identification information and the detected pieces of product identification information, the control unit 10 identifies coordinates on the captured image (S302).

Subsequently, based on the identified coordinates of the pieces of position identification information, the control unit 10 selects a pair of pieces of position identification information adjacent to each other (S303). Furthermore, based on the coordinates of the identified pair of respective pieces of position identification information, the control unit 10 calculates the line segment Y whose two ends are two positions associated with the selected pair of respective pieces of position identification information (S304). Based on the calculated line segment Y, the control unit 10 detects one of the pieces of product identification information included in the range R located within a given distance from the line segment Y (S305).

In a case where one of the pieces of product identification information is detected (S305: Yes), the control unit 10 determines that a product associated with the detected piece of product identification information is displayed between two positions associated with the selected pair of pieces of position identification information (S306), and based on the determination result, the control unit 10 records, in the product display position master 30, the piece of product identification information and the position information while associating the piece of product identification information and the position information with each other (S307). In accordance with the determination result, the control unit 10 creates and outputs the determination processing result screen 90 (S308).

On the other hand, in a case where no piece of product identification information is detected (S305: No), the control unit 10 returns to the processing operation in S303 and selects again another pair of pieces of position identification information adjacent to each other. After that, in the same way, the control unit 10 performs the processing operations ranging to S308.

For each combination of pieces of position identification information adjacent to each other, the control unit 10 performs the processing operations in S301 to S308. From this, for every combination of pieces of position identification information adjacent to each other and included in the captured image, which product is displayed is determined or whether no product is displayed is determined.

According to the third embodiment, a result of the determination processing for the display situation of a product, based on the processing device 100, is output. From this, it is possible for the user to confirm the result of the determination processing. Based on, for example, the determination processing, it is possible to confirm, for example, products whose positions are able to be determined, the number of the products whose positions are able to be determined, products whose positions fails to be determined, and the number of the products whose positions fail to be determined. Therefore, it becomes possible for, for example, the user to determine whether it is desirable to image-capture another captured image again.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method executed by a computer, the method comprising:
acquiring a captured image in which a product display shelf is image-captured;
detecting, from the captured image, first identification information associated with a first position in the product display shelf and second identification information associated with a second position in the product display shelf; and
determining that a display position of a product exists between the first position and the second position, in a case where product identification information associated with the product is detected at a position between the first identification information and the second identification information in the captured image.

2. The method according to claim 1, wherein
the first identification information and the second identification information are displayed at different positions in a front side surface of a specific shelf plate on which products are able to be placed and which is included in the product display shelf, and
the determining determines that the display position of the product corresponding to the product identification information exists between the first position and the second position in the specific shelf plate.

3. The method according to claim 1, wherein
the product display shelf includes two or more shelf plates on which products are able to be placed, and
in a case where the product identification information is detected at a position between the first identification information and the second identification information with respect to a specific shelf plate out of the two or more shelf plates in the captured image, the determining determines that the display position of the product exists between the first position and the second position in the specific shelf plate.

4. The method according to claim 1, wherein
the determining determines that the display position of the product corresponding to the product identification information exists between the first position and the second position in the specific shelf plate, in a case where the product identification information is detected within a predetermined distance from a line connecting the first identification information with the second identification information in the captured image.

5. The method according to claim 1, further comprising:
detecting a plurality of identification information from the captured image,
wherein
the detecting of the first identification information and the second identification includes:
specifying, as the first identification information and the second identification information, a set of identification information arranged adjacent to each other in the captured image among the plurality of identification information, and
repeating the specifying with regard to all sets of the identification information, and
the method further comprising:
determining whether the product identification information is detected at a position between the specified first identification information and the specified second identification information for each of all sets of the identification information.

6. The method according to claim 1, further comprising:
storing the first identification information and the second identification information in association with the product identification information into a product display position master when it is determined that the display position of the product exists between the first position and the second position.

7. A method executed by a computer, the method comprising:
acquiring a captured image of a product display shelf including one or more shelf plates, wherein the captured image includes pieces of identification information associated with respective different positions in the product display shelf and product identification information associated with a product;
detecting the two or more pieces of identification information that are associated with a specific shelf plate out of the one or more shelf plates and that are included in the pieces of identification information included in the acquired captured image; and
determining that a position between the two pieces of identification information is a display position of the product, wherein the two pieces of identification information are adjacent to each other, sandwich therebetween a position of the product identification information in the captured image, and are included in the detected two or more pieces of identification information.

8. A non-transitory storage medium storing a program for causing a computer to execute a process, the process comprising:
acquiring a captured image in which a product display shelf is image-captured;
detecting, from the captured image, first identification information associated with a first position in the product display shelf and second identification information associated with a second position in the product display shelf; and
determining that a display position of a product exists between the first position and the second position, in a case where product identification information associated with the product is detected at a position between the first identification information and the second identification information in the captured image.

9. The storage medium according to claim 8, wherein
the first identification information and the second identification information are displayed at different positions in a front side surface of a specific shelf plate on which products are able to be placed and which is included in the product display shelf, and
the determining determines that the display position of the product corresponding to the product identification information exists between the first position and the second position in the specific shelf plate.

10. The storage medium according to claim 8, wherein
the product display shelf includes two or more shelf plates on which products are able to be placed, and
in a case where the product identification information is detected at a position between the first identification information and the second identification information with respect to a specific shelf plate out of the two or more shelf plates in the captured image, the determining determines that the display position of the product exists between the first position and the second position in the specific shelf plate.

11. The storage medium according to claim 8, wherein
the determining determines that the display position of the product corresponding to the product identification information exists between the first position and the second position in the specific shelf plate, in a case where the product identification information is detected within a predetermined distance from a line connecting the first identification information with the second identification information in the captured image.

12. The storage medium according to claim 8, wherein
the process further comprising:
detecting a plurality of identification information from the captured image,
the detecting of the first identification information and the second identification includes:
specifying, as the first identification information and the second identification information, a set of identification information arranged adjacent to each other in the captured image among the plurality of identification information, and
repeating the identifying with regard to all sets of the identification information, and
the process further comprising:
determining whether the product identification information is detected at a position between the specified first identification information and the specified second identification information for each of all sets of the identification information.

13. The storage medium according to claim 8, wherein the process further comprising:
storing the first identification information and the second identification information in association with the product identification information into a product display position master when it is determined that the display position of the product exists between the first position and the second position.
